(19) United States
(12) Patent Application Publication
(10) Pub. No.: US 2010/0032493 A1
(43) Pub. Date: Feb. 11, 2010

(54) Precision variable rate irrigation system

(76) Inventors: Kevin Abts, Omaha, NE (US); Nick Emanuel, North Bend, NE (US)

Correspondence Address: THOMTE LAW OFFICE, L.L.C., 2120 S. 72ND STREET, SUITE 1111, OMAHA, NE, 68124, US

(21) Appl. No.: 12/584,622

(22) Filed: Sep. 9, 2009

Related U.S. Application Data
(63) Continuation-in-part of application No. 12/221,752, filed on Aug. 6, 2008.

(51) Int. Cl. B05B 3/00

(52) U.S. Cl. 239/11

(57) ABSTRACT

A method is described for automatically adjusting the water application rate of an irrigation system which is movable over an agricultural field, comprising the steps of: (a) processing one or more main field layers of geospatial data; (b) generating variable irrigation management zones dependent on the irrigation system in the field; and (c) adjusting water application from the irrigation system dependent on the spatial location of the irrigation system in the field and the underlying processed geospatial field data previously determined. The method may also use the step of utilizing one or more of the field layers to identify at least one optional crop sensor location within the field. The water application rate is adjusted by increasing or decreasing the speed of the irrigation system or by turning the irrigation system on or by turning the irrigation system off.

### CROSS-REFERENCE TO RELATED APPLICATION

This is a continuation-in-part application of application Ser. No. 12/221,752 filed Aug. 6, 2008 entitled ENVIRONMENTAL AND BIOTIC-BASED SPEED MANAGEMENT AND CONTROL OF MECHANIZED IRRIGATION SYSTEMS.

### BACKGROUND OF THE INVENTION

1. Field of the Invention

The invention of the co-pending application relates to the speed management and control of mechanized irrigation systems and more particularly to a system that based on changes in environmental conditions or agricultural crop or plant characteristics or dynamics, either automatically turns on the irrigation system or turns the irrigation system off, or increases or decreases the speed or rate of movement or rotation of the irrigation system or reports a recommended activation, deactivation or increased or decreased speed of rotation to the end user. More specifically, the instant invention relates to a precision variable rate irrigation system which emphasizes water use efficiency to conserve natural resources while reducing costs, optimizing yield and maximizing profits. The instant invention combines crucial agronomic spatial data layers to provide growers a complete field management program.

2. Description of the Related Art

As stated in the co-pending application, mechanized or self-propelled irrigation systems having elevated water booms are generally classified as either a center pivot irrigation system or as a laterally moving system which is also sometimes referred to as a lateral irrigation system, a linear irrigation system or an in-line irrigation system. In many instances, the center pivot irrigation systems include corner systems for irrigating the corners of a field. Normally, the irrigation systems include spaced-apart drive units or towers which not only support the water boom or water pipeline above the field but which also move the system over the field to be irrigated. Typically, in a center pivot irrigation system, the last regular drive unit (L.R.D.U.) is the master drive unit which is driven at a pre-set speed with the other drive units being “slave” drive units which are operated through an alignment system so that the drive units remain in a general alignment with each other. The speed of the master drive unit is set by a master percent timer that is either manually set or programmed at the center pivot or programmed remotely via telemetry. The speed of the master drive unit remains constant until the system is deactivated or the master percent timer is manually adjusted or automatically programmed so as to speed up the speed of the system or slow down the speed of the system.

In the lateral move or linear systems, any of the drive units may be the master drive unit, the speed of which is controlled by a master percent timer in the same fashion as in the center pivot irrigation systems.

Many of the mechanized irrigation systems of the prior art may be remotely controlled so as to begin irrigation or to halt irrigation. However, the activation and deactivation of the prior art irrigation systems are usually based upon an operator's visual observation of the condition of the crop and surrounding environment. In some instances, soil moisture sensors, canopy temperature sensors, plant turgidity sensors, stem growth sensors or the like are placed in the field to warn the operator that the crop is in stress or is being over watered, at which time the operator will either activate the irrigation system or deactivate the irrigation system. In some cases, the sensor system will automatically activate the irrigation system or deactivate the irrigation system. To the best of Applicants' knowledge, prior to the filing of the co-pending application, a system had not been previously developed which will either automatically activate the irrigation system, deactivate the irrigation system, increase the speed of the irrigation system or decrease the speed of the irrigation system to apply varying amounts of water in response to changes in field, crop or plant conditions which is a far more practical response than only being able to automatically start or stop the entire irrigation system. Starting a mechanized irrigation system often times requires the operator to be present to manually start up power units and ensure operational safety through visual observation. Due to slow rotation speeds, stopping a mechanized irrigation system often times causes unwanted delays in irrigation schedules. Frequent starting and stopping can also create additional wear and tear on the irrigation system. The system described in the co-pending application provided a means for automatically increasing or decreasing the speed of the irrigation system and even stopping or starting the irrigation system. Although the system described in the co-pending application represents a vast improvement in the irrigation art, Applicants' instant invention further enhances the invention of the co-pending application by providing a variable rate irrigation system which combines crucial agronomic spatial data layers and an in-field sensor or sensors to provide growers a complete field management program.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In the co-pending application, a system was described that based on changes in agricultural crop or plant characteristics or dynamics, e.g., heat stress, water deficit stress, stem growth, leaf thickness, plant turgidity, plant color, nutrient composition, etc., or changes in environmental conditions, e.g., temperature, wind, pressure, relative humidity, dew point, precipitation, soil moisture, solar radiation, etc. or a combination of both, e.g., evapotranspiration, either deactivates the irrigation system, activates the irrigation system, and being able to also automatically increase or decrease the speed or rate of movement of a mechanized irrigation system, e.g., center pivot, corner, linear, or lateral move irrigation system or similar systems, or reports a recommended activation, deactivation or increased or decreased speed or rate of movement or rotation of a mechanized irrigation system either directly or indirectly to the end user. The system of the co-pending application responds directly or indirectly to data outputted from monitoring systems that gather and compile environmental (non-biotic), biotic or similar information from agricultural fields and crops or plants. The system is comprised of an algorithm, table or the like that computes, calculates or otherwise determines an optimal control speed based on real-time or historical field and crop or plant data as well as irrigation management parameters, i.e., water application depth, time averages, information thresholds, weather forecasts, etc. that can be optionally configured by the end user, downloaded from the web or inputted through remote irrigation management technology systems. The recommended control speed is then either reported to the end user via the World Wide Web, mobile Web, email, personal computer, SMS (short message service), MMS (multimedia message service), pager, manual or automated voice phone call out, RF (radio frequency) communication device which automatically activates a speed timer, percent timer, percent rate timer, or speed control device or similar of the corresponding mechanized irrigation system at the recommended control speed. The system of the co-pending application provides optimal irrigation application management that conserves water resources by reducing wasteful overwatering, ensures against irreversible crop damage resulting from both overwatering and underwatering and increases total farm output and profitability by improving overall quality, yield and management of agricultural crops or plants.

The invention of this continuation-in-part application is used with the system of the co-pending application to provide growers with a complete field management program. The instant invention relates to a precision variable rate; irrigation technology or system that emphasizes water use efficiency to reduce input costs, optimizing yield and maximizing profits. The instant invention creates agronomic spatial data layers such as EM or EC survey information, topography (elevation), remote sensing and raw yield. Preferably, crop sensor data is also employed through the use of an IR thermometer, moisture probe, stem/leaf thickness sensor, dendrometer, or other remote sensing equipment.

Based on the data for a particular field, the irrigation system may be activated, deactivated, or the speed thereof increased or decreased. The pulsing of sprinklers or sprinkler banks of the irrigation system may also be controlled. The amount of water supplied to the system and the pressure thereof may also be varied. Thus, those parts of the field requiring more or less irrigation water will receive the proper amount of water without wastage of water. The system may also be used to apply the proper amounts of fertilizer to specific areas within the field.

The principal object of the invention is to provide a system for the management and control of mechanized irrigation systems which automatically adjusts watering application rates.

A further object of the invention is to provide a system of the type described wherein geospatial data layers are created which are combined with crop sensor data to determine when and how much to vary the rate of irrigation and fertigation relative to pivot field location.

A further object of the invention is to provide a system of the type described which enables a crop sensor to be optimally placed in a field to ensure accurate adjustment of crop sensor data relative to pivot field location.

A further object of the invention is to provide a system of the type described wherein the cycling or pulsing of individual sprinklers or sprinkler banks may be employed to provide to variably apply irrigation water or fertilizer to the field.

A further object of the invention is to provide a system wherein the speed of the irrigation pumps VFD (variable frequency drive) may be increased or decreased relative to pivot field location.

A further object of the invention is to provide a system of the type described where telemetry may be used to combine processed geospatial data information, crop sensor information and variable rate irrigation management and control.

A further object of the invention is to provide a system of the type described including means to automatically vary the application rate of irrigation and fertigation through a combination of processed geospatial data information, crop sensor information and variable rate irrigation management and control.

A further object of the invention is to provide a system of the type described wherein the variable irrigation application rates will automatically adjust spatially throughout the field dependent on the base application rate entered and the percent or fraction difference in the varying irrigation management zone.

A further object of the invention is to provide a system of the type described wherein the variable irrigation application rates are automatically adjusted spatially throughout the field dependent on the condition or needs of the crop as sensed by one or more crop sensors.

A further object of the invention is to provide a system of the type described wherein the variable irrigation application rates are automatically adjusted spatially throughout the field when base application rates are updated or entered via the World Wide Web, mobile Web, email, personal computer, SMS (short message service), MMS (multimedia message service), pager, manual or automated voice phone call out, or a RF (radio frequency) communication device.

A further object of the invention is to provide a system of the type described wherein the variable irrigation application rates are automatically adjusted spatially throughout the field when the base application rates are manually updated or entered into a controller on an associated mechanized irrigation system.

A further object of the invention is to provide a system of the type described wherein the variable irrigation application rates are automatically adjusted spatially throughout the field when base application rates are remotely or wirelessly updated or entered into a controller on an associated mechanized irrigation system.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified;

FIG. 1 is a perspective view of a conventional center pivot irrigation system;

FIG. 2 is a schematic drawing illustrating a center pivot irrigation system with field sensors positioned in the field being irrigated;

FIG. 3 is an overview block diagram;

FIG. 4. is a block diagram of the speed control device of this invention;

FIG. 5 is a block diagram of Stage 1 of this invention;

FIG. 6 is a block diagram of Stage 2 of this invention;

FIG. 7 is a block diagram of Stage 3a of this invention;

FIG. 8 is a block diagram of Stage 3b of this invention;

FIG. 9 is a block diagram of Stage 4 of this invention;

FIG. 10 is a printout of an algorithm which combines heat stress time threshold data with user defined parameters;

FIG. 11 is a graph or chart which illustrates the roles of the various system components and the manner in which the crop consultant or agronomist relates to the three main system components that enable the automatic variable application rate of irrigation water or fertilizer;

FIG. 12 is a graph or chart which illustrates the manner in which the three main system components are combined to optimize and enable the automatic variable application rate of irrigation water or fertilizer; and

FIG. 13 is a diagram which illustrates a center pivot irrigation system being divided into optimal slices or zones, dependent on an analysis of the underlying geospatial field data, to provide a basis for the automatic variable application rate of irrigation water or fertilizer with the diagram also indicating optimal location of environmental or crop sensor placement.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

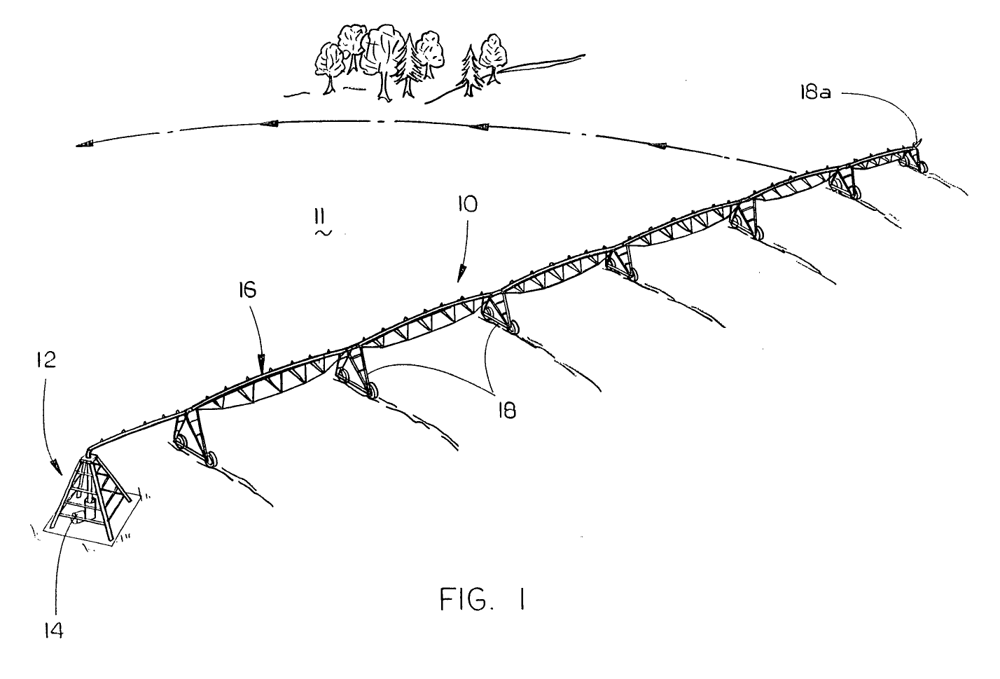

FIGS. 1-10 are the drawings of the co-pending application. In FIG. 1, the numeral 10 refers to a conventional center pivot irrigation system having a center pivot structure 12 at its inner end. Center pivot structure 12 includes a vertically disposed water pipe 14 which is in communication with a source of water under pressure. An elevated water boom or pipeline 16 is pivotally connected at its inner end to the center pivot structure 12 with the pipeline 16 being in fluid communication with water pipe 14. The pipeline 16 is supported by a plurality of spaced-apart drive units or towers 18 in conventional fashion. The numeral 18a refers to the last regular drive unit (L.R.D.U.) which usually is the master tower. A master percent timer is operatively connected to the electric motor on L.R.D.U. 18a which either activates the movement of L.R.D.U. 18a or deactivates the same in conventional fashion. It is the type of mechanized irrigation system shown in FIG. 1 that the speed management system 20 of this invention will be used. The speed management system 20 may be used with other types of mechanized irrigation systems such as corner systems, linear systems or lateral move irrigation systems or the like.

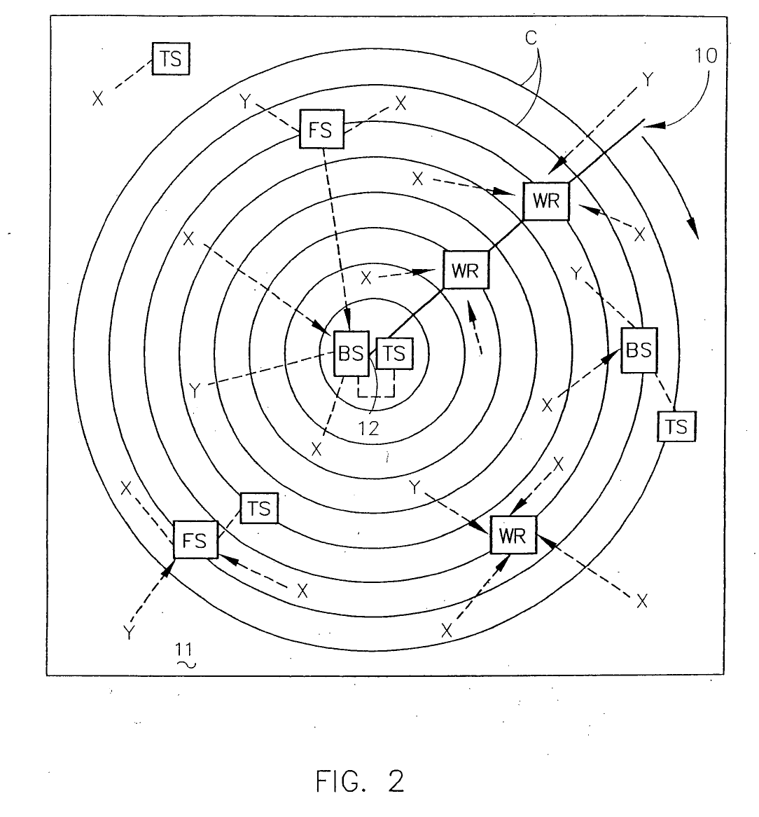

Referring to FIG. 2, the center pivot irrigation system 10 is positioned in the field 11 and travels in a clockwise direction around the center pivot structure 12. The circles C represent the path that each of the drive units 18 will take as they move through the field 11.

A base station BS with a processor is located in the field 11, on the irrigation system 10 or at a remote site such as a computer, web server and/or similar device. A telemetry system TS is preferably positioned adjacent the base station BS for remote two-way data communication to a personal computer, web server and/or similar device. A plurality of field stations FS are located in the field 11 and are either hand wired or wireless so as to receive data and transmit the same. Telemetry systems TS are also located adjacent the field stations FS for transmitting data to a personal computer, web server and/or similar device.

A plurality of wireless receivers WR are either mounted on the system 10 or in the field 11 for collecting field sensor data. A plurality of biotic field sensors X transmit crop or plant data either wired or wirelessly. A plurality of environmental (non-biotic) field sensors transmit field data either wired or wirelessly.

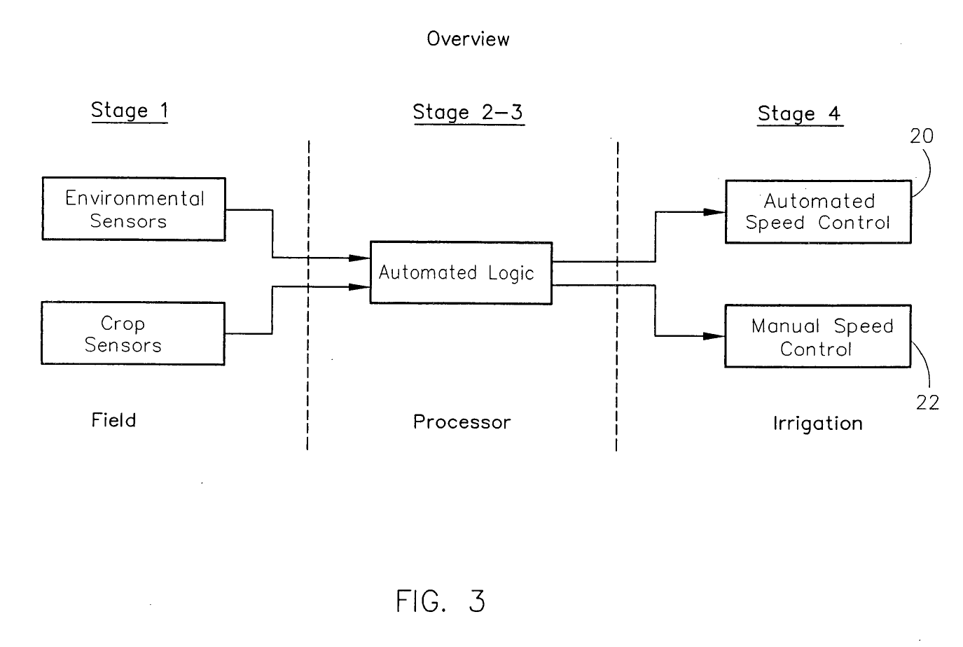

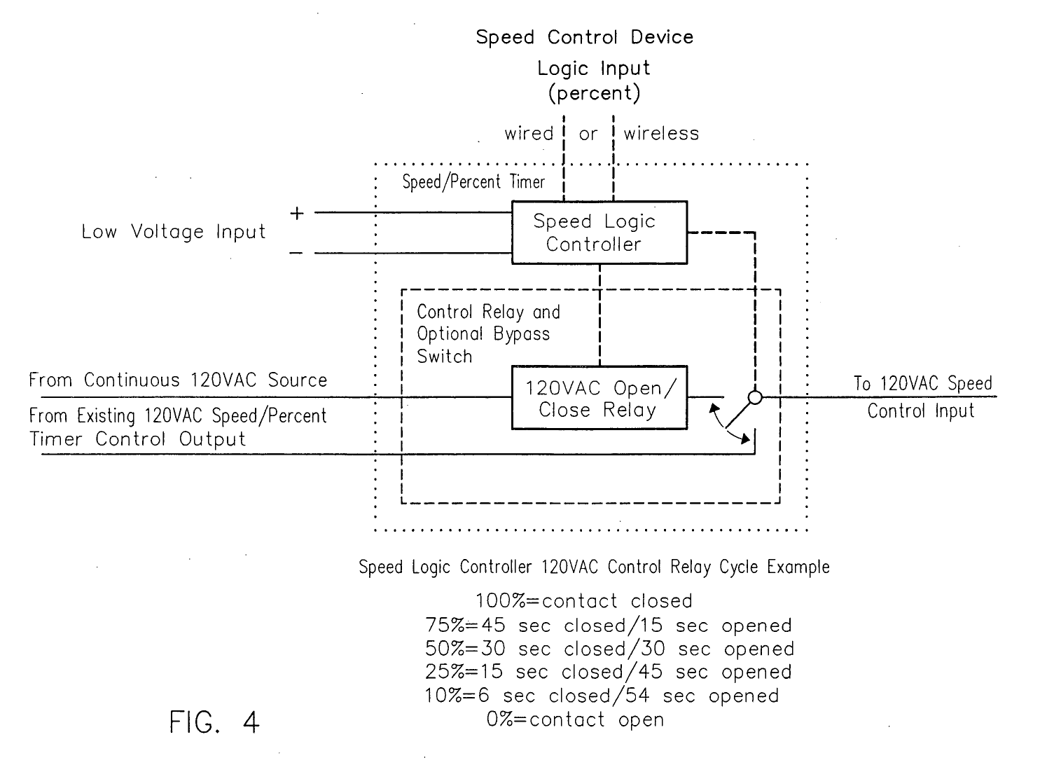

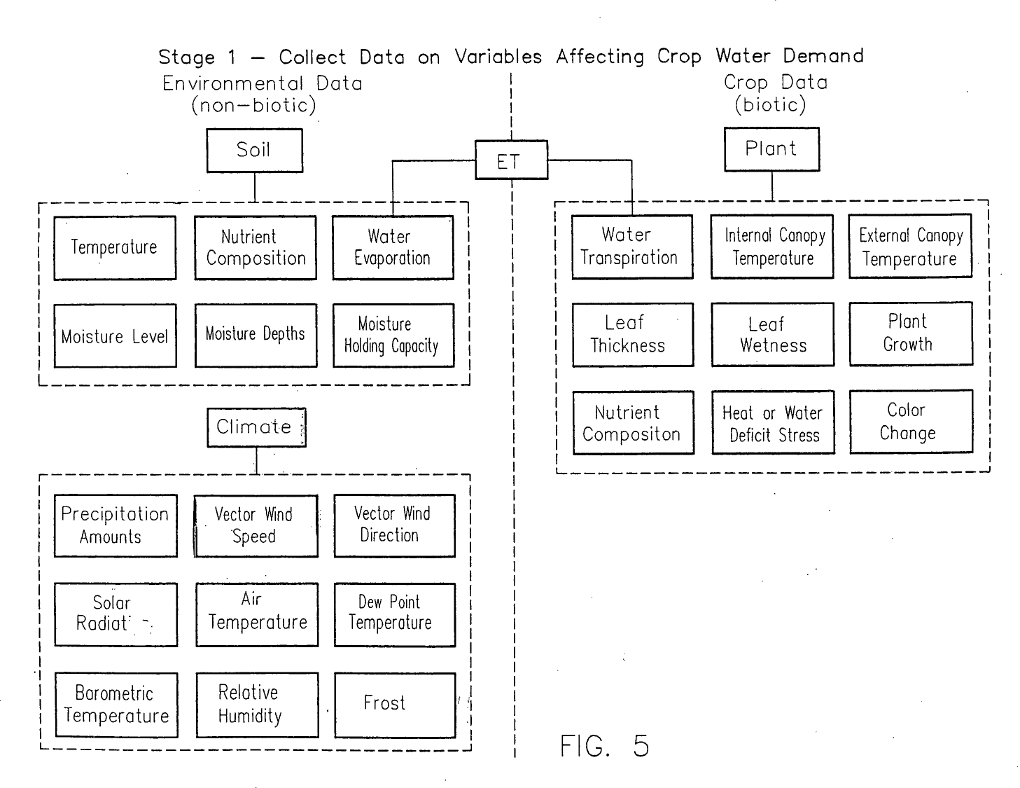

In the overview block diagram of FIG. 3, it can be seen that the data from the environmental sensors and crop or plant sensors in the field 11 is transmitted to a processor having automated logic which in turn transmits central signals to an automatic speed control device 20 or to an operator who controls a manual speed control device 22 for the irrigation system 10. FIG. 4 illustrates the operation of the automatic speed control device 20. FIG. 5 depicts stage 1 of the operation of the instant invention. As seen, environmental data is collected by the environmental field sensors. Data is collected concerning temperature, moisture levels, nutrient composition, moisture depths, water evaporation and moisture holding capacity. Data is also collected regarding climate such as precipitation amounts, solar radiation, barometric temperature, vector wind speed, air temperature, relative humidity, vector wind direction, dew point temperature and frost. Crop data is collected by the field sensors FS relating to the crop plant such as water transpiration, leaf thickness, nutrient composition, internal canopy temperature, leaf wetness, heat or water deficit stress, external canopy temperature, plant growth and color change.

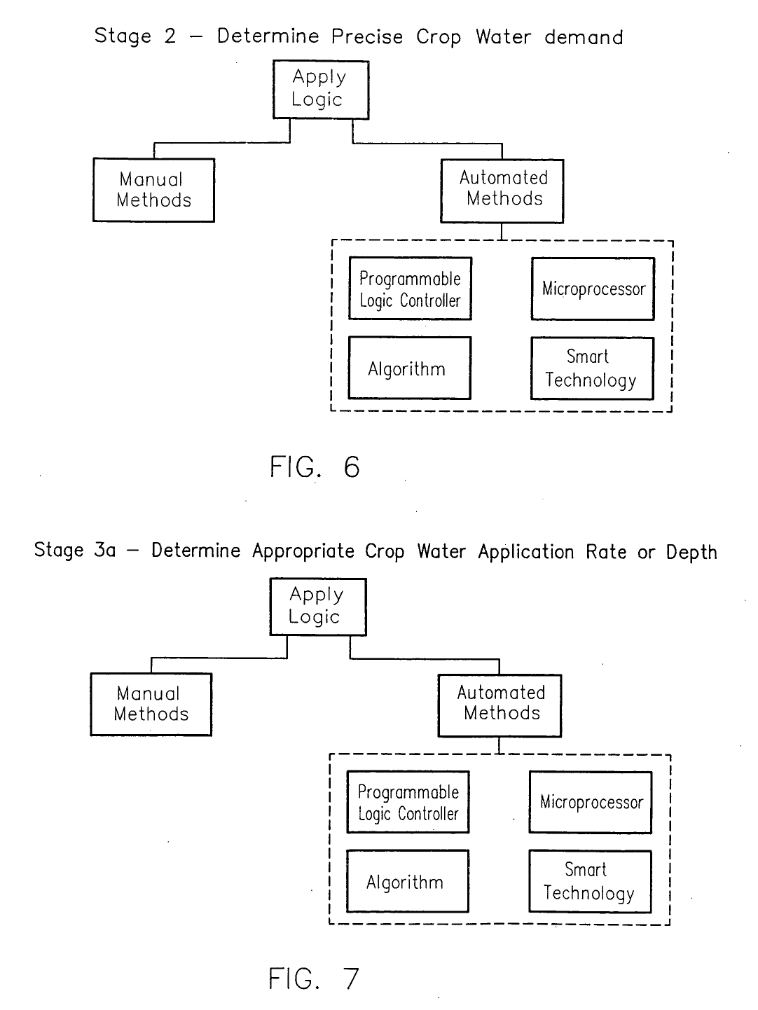

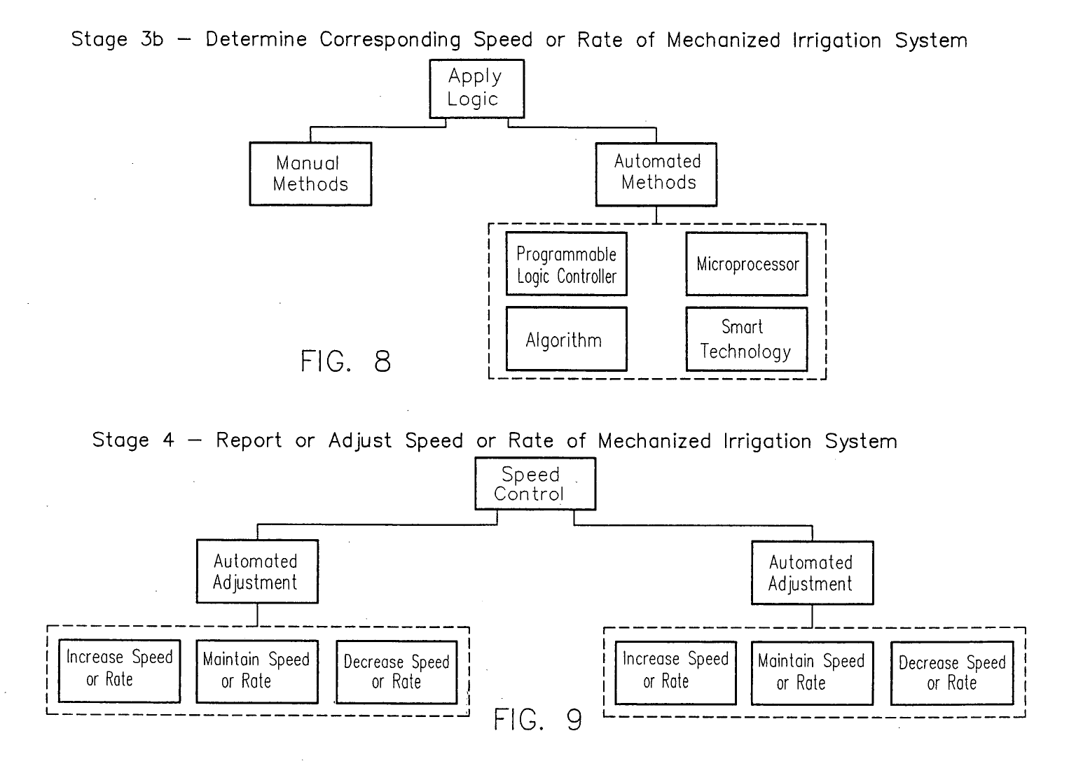

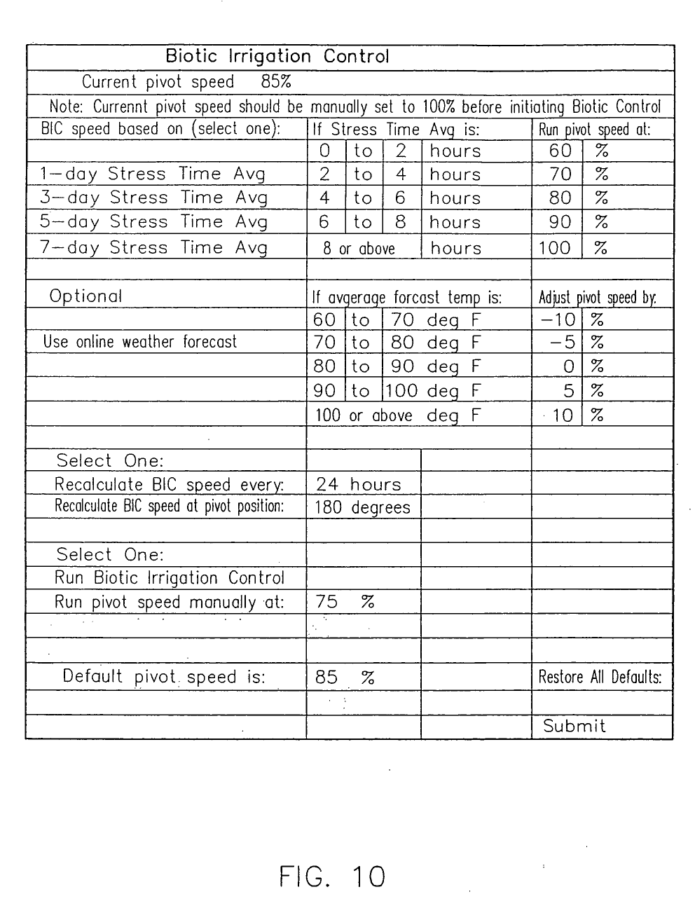

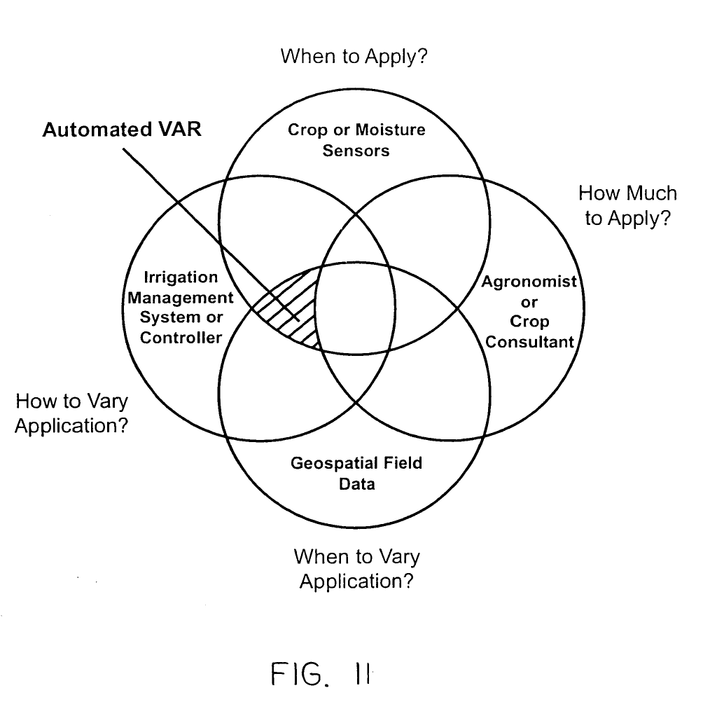

After the data has been collected as illustrated in Stage 1 (FIG. 5), the computer applies logic with respect to manual and automated crop water demand as illustrated in Stage 2 (FIG. 6). Stage 3a (FIG. 7) illustrates the manner in which the appropriate crop water application rate or depth is determined. FIG. 8 (Stage 3b) illustrates the manner in which the corresponding speed or rate of the irrigation system is determined. After the speed or rate of the irrigation system is determined in Stage 3b, that information is either reported to the end user for manual adjustment of the speed of the irrigation system or the speed of the irrigation system is automatically adjusted as seen in Stage 4 (FIG. 9). FIG. 10 illustrates a biotic control algorithm that combines heat stress time threshold data with user defined parameters.

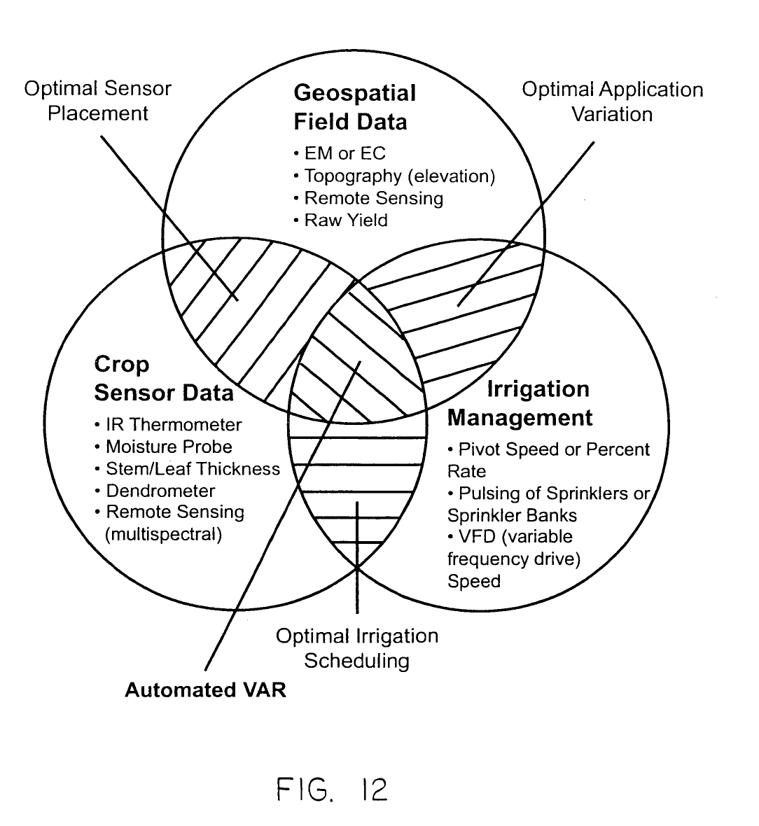

The instant invention will now be described with reference to FIGS. 11-13.

Referring now specifically to the drawings, FIG. 11 depicts a graph or chart which illustrates the roles of the various system components and the manner in which the crop consultant or agronomist may relate to the three main system components that enable the automatic variable application rate of irrigation water or fertilizer. The agronomist or crop consultant may advise a grower how much water or fertilizer should be applied to the grower's crops at any given time. Sensors in the field may be utilized to determine when the grower should apply the water or fertilizer to the grower's crops. The analysis of geospatial field data may be used to determine when or at what points in the field the grower should vary the application of water or fertilizer as the application mechanism changes locations. An irrigation controller may be used to change or vary the application rate as the application mechanism changes locations. Once the application amount is determined, sensors, geospatial field data and an irrigation controller may be combined to enable the automatic variable application rate of water including the starting and stopping of irrigation water or fertilizer.

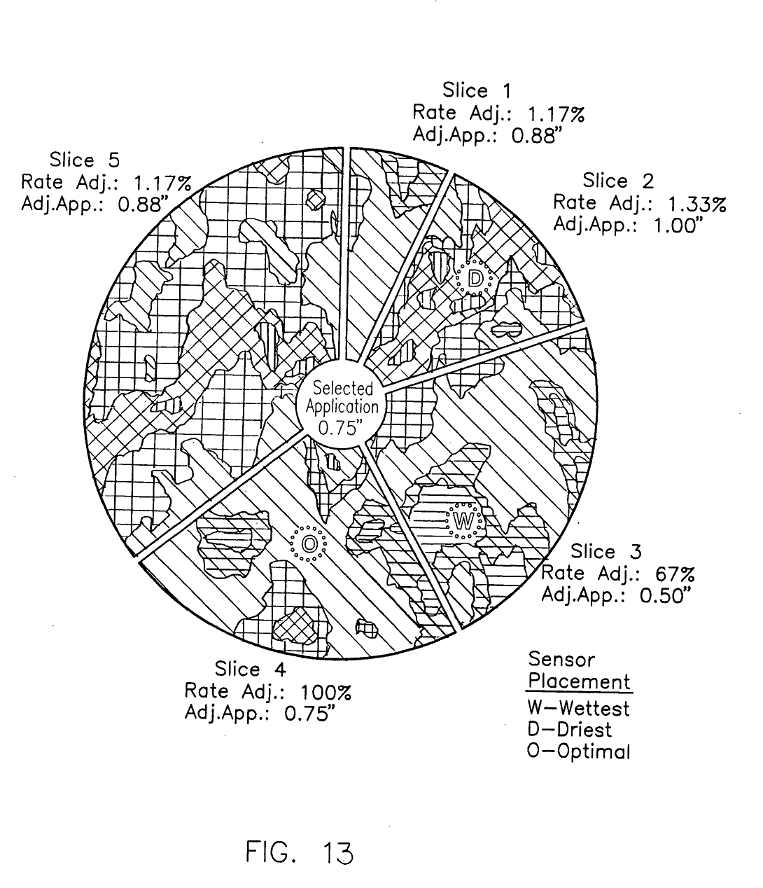

With respect to FIG. 12, a chart or graph is depicted which illustrates how the three main system components are combined to optimize and enable the automatic variable application rate of irrigation water or fertilizer.

FIG. 13 is a diagram which illustrates a center pivot irrigation system being divided into optimal slices or zones, dependent on careful analysis of the underlying geospatial field data, to provide a basis for the automatic variable application rate of irrigation water or fertilizer. The diagram of FIG. 13 also indicates optimal location of environmental or crop sensor placement.

The instant invention relates to a device, system or means that based on changes in agricultural crop or plant characteristics or dynamics (EG), heat stress, water deficits, stress, stem growth, leaf thickness, plant color, nutrient composition, etc. (or changes in the environmental conditions) EG, temperature, wind, pressure, relative humidity, dew point, precipitation, soil moisture, solar radiation, etc. (or a combination of both or EG, evapotranspiration), combined with processed geospatial data, automatically increases or decreases the speed of an irrigation pumps variable frequency drive and the water output of individual sprinklers or sprinkler banks and the speed or rate of movement or rotation of a mechanized irrigation system dependent on the current geospatial location of the mechanized irrigation system.

The device, system or means responds directly or indirectly to data outputted from monitoring systems that gather and compile biotic or similar plant information from agricultural fields and crops and are placed in optimal field locations. The device, system or means then adjusts watering applications dependent on spatial location of center pivot and underlying processed spatial field data. The device, system or means is comprised of an algorithm, operator, table, chart, graph or similar that computes, calculates or otherwise determines an optimal irrigation scheduling, management or control status based on real-time or historical field and crop data in combination with agronomic important spatial field data as well as irrigation management parameters, i.e., water application depth, water amounts, watering time, time averages, information thresholds, weather forecasts, etc., that can be optionally configured by the end user, downloaded from the web or inputted from telemetry or remote irrigation management systems. The recommended irrigation management status is then either reported to the end user via the World Wide Web, mobile Web, e-mail, personal computer, SMS (short message service), MMS (multimedia message serve), pager, manual or automated voice phone call out, RF (radio frequency) communication device or similar or automatically starts or stops pumps or irrigation systems, increases or decreases water pressures, flow rates or variable frequency drives, or opens or closes water valves of the corresponding mechanized irrigation systems.

Mechanized irrigation systems may be managed or controlled via zones that are comprised of individual sections, center pivot slices, or sections within center pivot slices. This device, system or means provides optimal irrigation application management that conserves water resources by reducing wasteful overwatering, ensures against irreversible crop damage resulting from both overwatering and underwatering and increases total farm output and profitability by improving overall quality, yield and management of agricultural crops.

In summary, it can be seen that in the instant invention, the management and control of mechanized irrigation systems and irrigation pump variable frequency drives is provided to automatically adjust watering application rates based on sensor data coming directly from the plants being watered as well as the current location of the mechanized irrigation system and the underlying geospatial processed information.

Thus it can be seen that a system has been provided for sensing crop conditions, determining irrigation water needs, and then either reporting to the end user the proper speed at which the irrigation system should be operated or to automatically adjust the speed of the irrigation system according to the collected data.

It can also be seen that a system of the present invention enables variable irrigation application rates to be automatically adjusted spatially throughout the field dependent on the base application rate entered and the percent or fraction difference in the varying irrigation management zones. It can also be seen that Applicants have provided a system wherein the variable irrigation application rates are automatically adjusted spatially throughout the field dependent on the condition or needs of the crop as sensed by one or more crop sensors. It can also be seen that Applicants have provided a system wherein the variable irrigation application rates are automatically adjusted spatially throughout the field when base application rates are updated or entered via the World Wide Web, mobile Web, email, personal computer, SMS (short message service), MMS (multimedia message service), pager, manual or automated voice phone call out, or a RF (radio frequency) communication device.

It can also be seen that Applicants have provided a system wherein the variable irrigation application rates are automatically adjusted spatially throughout the field when base application rates are automatically updated or entered into a controller on an associated mechanized irrigation system. Further, it can be seen that Applicants have provided a system wherein the variable irrigation application rates are automatically adjusted spatially throughout the field when base application rates are remotely or wirelessly updated or entered into a controller on an associated mechanized irrigation system.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A method of variably supplying irrigation water to an irrigation system which is movable over an agricultural field, comprising the steps of:
processing one or more main field layers of geospatial data with the field layers selected from: (1) an EM or EC survey; (2) topography; (3) yield; and (4) remotely sensed images;
generating variable irrigation management zones dependent on the irrigation system in the field;
adjusting water application from the irrigation system dependent on the spatial location of the irrigation system in the field and the underlying processed geospatial field data previously determined.

2. The method of claim 1 further including the step of utilizing one or more of the field layers to identify at least one optional crop sensor location within the field.

3. The method of claim 2 wherein a plurality of crop sensors are placed within the field.

4. The method of claim 1 wherein the water application is adjusted by increasing or decreasing the speed of the irrigation system.

5. The method of claim 1 wherein the irrigation system includes spaced-apart sprinklers thereon and wherein the water application is adjusted by activating predetermined sprinklers.

6. The method of claim 1 wherein the water application is adjusted by varying the flow of water to the irrigation system.

7. The method of claim 1 wherein the irrigation system is a center pivot irrigation system.

8. The method of claim 7 wherein the center pivot irrigation system includes a corner system.

9. The method of claim 1 wherein the irrigation system is a linear move irrigation system.

10. The method of claim 1 wherein the irrigation system is a lateral move irrigation system.

11. The method of claim 2 wherein a crop sensor is positioned in the field.

12. The method of claim 11 wherein the crop sensor is a heat stress sensor.

13. The method of claim 11 wherein the crop sensor is a water deficit stress sensor.

14. The method of claim 11 wherein the crop sensor is a stem growth sensor.

15. The method of claim 11 wherein the crop sensor is a leaf thickness sensor.

16. The method of claim 11 wherein the crop sensor is a plant turgidity sensor.

17. The method of claim 11 wherein the crop sensor is a plant color sensor.

18. The method of claim 11 wherein the crop sensor is a nutrient composition sensor.

19. The method of claim 11 wherein the crop sensor is a temperature sensor.

20. The method of claim 11 wherein the crop sensor is a wind sensor.

21. The method of claim 11 wherein the crop sensor is a pressure sensor.

22. The method of claim 11 wherein the crop sensor is a relative humidity sensor.

23. The method of claim 11 wherein the crop sensor is a dew point sensor.

24. The method of claim 11 wherein the crop sensor is a soil moisture sensor.

25. The method of claim 11 wherein the crop sensor is a solar radiation sensor.

26. The method of claim 1 wherein the water application is automatically controlled by a remote control means.

27. The method of claim 1 wherein the water being applied to the field includes fertilizer.

28. The method of claim 1 wherein the water application rate is automatically adjusted.

29. A method of variably supplying irrigation water to an irrigation system which is movable over an agricultural field, comprising the steps of:
processing one or more main field layers of geospatial data;
and automatically adjusting the rate of water application dependent on the spatial location of the irrigation system in the field and the underlying processed geospatial data.

30. The method of claim 29 wherein one or more crop sensors are placed in the field and wherein the rate of water application is also dependent on the condition of the crop as sensed by the one or more crop sensors.

31. The method of claim 1 wherein the variable irrigation application rates are automatically adjusted spatially throughout the field dependent on the base application rates entered and the percent or fraction difference in the varying irrigation management zones.

32. The method of claim 2 wherein the variable irrigation application rates are automatically adjusted spatially throughout the field dependent on the condition or needs of the crop as sensed by one or more crop sensors.

33. The method of claim 1 wherein the variable irrigation application rates are automatically adjusted spatially throughout the field when base application rates are updated or entered via the World Wide Web, mobile Web, email, personal computer, SMS (short message service), MMS (multimedia message service), pager, manual or automated voice phone call out, or a RF (radio frequency), communication device.

34. The method of claim 1 wherein the variable irrigation application rates are automatically adjusted spatially throughout the field when base application rates are manually updated or entered into a controller or an associated mechanized irrigation system.

35. The method of claim 1 wherein the variable irrigation application rates are automatically adjusted spatially throughout the field when base application rates are remotely or wirelessly updated or entered into a controller or an associated mechanized irrigation system.
